(19) United States
(12) Patent Application Publication
(10) Pub. No.: US 2026/0301594 A1
(43) Pub. Date: Oct. 1, 2026

(54) METHOD AND SERVER DEVICE FOR INTERACTIVE LEARNING

(71) Applicant: National Taiwan Normal University, Taipei City (TW)

(72) Inventors: Jon-Chao HONG, Taipei City (TW); Huan YEH, Taipei City (TW); Chi Chin WONG, Taipei City (TW)

(73) Assignee: National Taiwan Normal University, Taipei City (TW)

(21) Appl. No.: 19/359,919

(22) Filed: Oct. 16, 2025

(30) Foreign Application Priority Data
Mar. 27, 2025 (TW) 114111864

(51) Int. Cl. G09B 7/02; G06N 3/042

(52) U.S. Cl. CPC G09B 7/02; G06N 3/042

(57) ABSTRACT

A method for providing interactive learning is implemented using a server device that stores a large language model (LLM) and entries of knowledge data that correspond with a plurality of knowledge texts, respectively, the method includes: in response to receipt of a question string, obtaining an entry of target knowledge data and an answer string; obtaining and transmitting an inquiring string that is different from an answer of a preset question, and transmitting the inquiring string; in response to receipt of a first reply string, determining whether the first reply string corresponds with the answer of the preset question; in the case that the first reply string does not correspond with the answer of the preset question, obtaining a hinting string based on the first reply string and the entry of target knowledge data, the hinting string including hints to the answer.

### CROSS-REFERENCE TO RELATED APPLICATION

This application claims priority to Taiwanese Invention Patent Application No. 114111864, filed on Mar. 27, 2025, the entire disclosure of which is incorporated by reference herein.

### FIELD

The disclosure relates to a method and a server device for providing education, and more particularly to a method and a server device for interactive learning based on the scaffolding theory.

### BACKGROUND

In the field of educational psychology, the scaffolding theory or instructional scaffolding is an important concept. In practice, a learning process may be designed to imitate a scaffold on a construction site, which provides support to a student during the learning process to complete tasks that cannot be completed by the student alone. As the skills and ability of the student increase, an amount of support may be gradually reduced, until the student is able to complete the tasks alone.

As the technology of computer science advances, the application of human-computer interaction (HCI) in providing learning processes has been increasingly in demand.

It is noted that in the current practice, using HCI in providing learning processes may only involve asking questions and providing correct answers, and it may be beneficial to incorporate the scaffolding theory to provide the student with an improved interactive learning method.

### SUMMARY

Therefore, one object of the disclosure is to provide a method that can alleviate at least one of the drawbacks of the prior art.

According to one embodiment of the disclosure, the method for interactive learning for a user to obtain a correct answer to a preset question is implemented using a server device that is in communication with a user device held by the user. The server device stores a large language model (LLM) and a plurality of entries of knowledge data that are related to a plurality of knowledge texts, respectively. The method includes:
a) in response to receipt of a question string from the user device, obtaining at least one entry of target knowledge data that is selected from the plurality of entries of knowledge data and that is associated with the correct answer of the present question;
b) using the LLM to obtain an answer string from the entry of target knowledge data;
c) using the LLM to obtain an inquiring string based on the entry of target knowledge data, the inquiring string being different from the correct answer of the preset question, and transmitting the inquiring string to the user device;
d) in response to receipt of a first reply string from the user device, determining whether the first reply string conforms with the correct answer of the preset question;
e) in the case that the first reply string does not conform with the correct answer of the preset question, using the LLM to obtain a hinting string based on the first reply string and the entry of target knowledge data, and transmitting the hinting string to the user device, the hinting string including hints to instruct the user to continue thinking for the correct answer to the preset question;
f) in response to receipt of a second reply string from the user device, determining whether the second reply string conforms with the correct answer of the preset question; and
g) in the case it is determined that the second reply string does not conform with the correct answer of the preset question, obtaining and transmitting one of a first partial answer string and the answer string to the user device, the first partial answer string being obtained based on one of the feedback strings and the answer string.

Another object of the disclosure is to provide a server device that is configured to implement the above-mentioned method.

According to one embodiment of the disclosure, the server device for interactive learning for a user to obtain a correct answer to a preset question includes a server communication module for establishing a communication with a user device held by the user, a server data storage module that stores a large language model (LLM) and a plurality of entries of knowledge data that are related to a plurality of knowledge texts, respectively, and a server processor that is electrically connected to the server communication module and the server data storage module. The server processor is programmed to:
in response to receipt of a question string from the user device, obtain at least one entry of target knowledge data that is selected from the plurality of entries of knowledge data and that is associated with the correct answer of the present question;
use the LLM to obtain an answer string from the entry of target knowledge data;
use the LLM to obtain an inquiring string based on the entry of target knowledge data, the inquiring string being different from the correct answer of the preset question, and control the server communication module to transmit the inquiring string to the user device;
in response to receipt of a first reply string from the user device, determine whether the first reply string conforms with the correct answer of the preset question;
in the case that the first reply string does not conform with the correct answer of the preset question, use the LLM to obtain a hinting string based on the first reply string and the entry of target knowledge data, and control the server communication module to transmit the hinting string to the user device, the hinting string including hints to instruct the user to continue thinking for the correct answer to the preset question;
in response to receipt of a second reply string from the user device, determine whether the second reply string conforms with the correct answer of the preset question; and
in the case it is determined that the second reply string does not conform with the correct answer of the preset question, control the server communication module to transmit one of a first partial answer string and the answer string to the user device, the first partial answer string being obtained based on one of the feedback strings and the answer string.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a system for implementing a method for interactive learning according to one embodiment of the disclosure.

FIGS. 2, 3 and 4 constitute a flow chart of an exemplary learning interactive process of the method according to one embodiment of the disclosure.

FIG. 5 is a flow chart illustrating sub-steps of the operations of step S104 of the method according to one embodiment of the disclosure.

FIG. 6 is a flow chart illustrating sub-steps of the operations of step S111 of the method according to one embodiment of the disclosure.

FIG. 7 is a flow chart illustrating sub-steps of the operations of step S122 of the method according to one embodiment of the disclosure.

FIGS. 8 and 9 constitute a flow chart of an exemplary memory assistance process of the method according to one embodiment of the disclosure.

FIG. 10 is a flow chart of an exemplary learning reminder process of the method according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

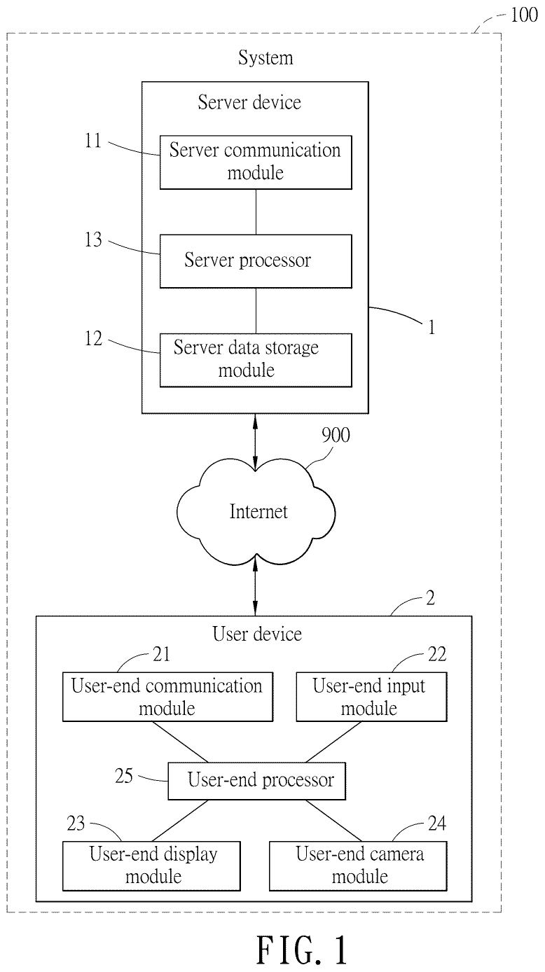

FIG. 1 is a block diagram of a system 100 for implementing a method for interactive learning according to one embodiment of the disclosure. In this embodiment, the system 100 includes a server device 1, and a user device 2 that is connected to the server device 1. The user device 2 may be held by a user, and is in connection with the server device 1 via a wireless communication using a network 900 such as the Internet.

The server device 1 may be embodied using a server, a personal computer or other suitable electronic devices, and includes a server communication module 11, a server data storage module 12, and a server processor 13.

The server communication module 11 may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. The server communication module 11 is configured to establish a wireless communication to the user device 2.

The server processor 13 is electrically connected to the server communication module 11 and the server data storage module 12, and may be embodied using a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), and/or a radio-frequency integrated circuit (RFIC), etc.

The server data storage module 12 may include one or more of, for example, random access memory (RAM), read only memory (ROM), programmable ROM (PROM), firmware, flash memory or other suitable non-transitory storage media. In this embodiment, the server data storage module 12 stores a software application therein. The software application includes instructions that, when executed by the server processor 13, causes the server processor 13 to implement operations as described below.

In this embodiment, the server data storage module 12 stores a large language model (LLM), a plurality of entries of knowledge data that related to a plurality of knowledge texts, a plurality of positive terms for encouraging the user, a plurality of feedback categories each being associated with a specific feedback style, a plurality of knowledge graphs that correspond respectively with the plurality of entries of knowledge data, a learning questionnaire that is designed for discovering a learning status of the user, a learning record associated with the user, a plurality of suggestion strings that correspond respectively with a plurality of different learning styles, and a style classification algorithm that is configured to classify the user into one of the plurality of different learning styles. Each of the feedback categories includes a plurality of feedback strings. The learning record may include one or more of a reading record and a completed test record, or other suitable records associated with the learning of the user.

In embodiments, the term “knowledge text” refers to a unit of information containing educational content. It may include textbook knowledge, instructional material, conceptual explanations, example problems, and application descriptions. It is used to support student learning and serves as the basis for artificial intelligence (AI) models to generate questions, hints, and answers. Examples of knowledge text include, but not limited to, “The sum of the interior angles of a triangle is 180 degrees.” or “Water can exist in solid (ice), liquid (water), and gaseous (water vapor) states at different temperatures. This process is called the phase change of matter and includes physical changes such as melting, evaporation, and condensation.”

In embodiments, a plurality of knowledge texts are prepared to serve as a source and basis for the plurality of entries of knowledge data.

In embodiments, the term “suggestion string” refers to a pre-stored textual recommendation in the server device 11, which corresponds to one of many different learning styles. It is used to provide personalized learning strategies or motivational advice based on the user's learning behavior and classified learning style. In some examples, when a user is classified as a visual learner, the suggestion string may be “You can try drawing a diagram of this concept to help with understanding”. When a user is classified as a reflective learner, the suggestion string may be “Take a minute to think about the underlying logic of this question”.

The following Table 1 illustrates an exemplary list of the feedback categories, including, for example, an evaluation category, an effectiveness category and an action category. Each of the feedback categories includes a number of exemplary feedback strings.

TABLE 1

| Feedback | Evaluation | Effectiveness | |
|---|---|---|---|
| categories | category | category | Action category |
| Feedback | Very smart! | Really effective! | Try the next question. |
| string | Very good! | Problematic. | Please try the next |
| | | | question. |
| | It's wrong. | That's something | Come on, let's try |
| | | | another question! |
| | It's incorrect. | High standard! | Think about it. |
| | A bit sloppy. | Not very effective. | Use the head. |

In some embodiments, the plurality of entries of knowledge data are constructed using retrieval augmented generation (RAG), and is configured to be used by the LLM. For each of the plurality of entries of knowledge data, the server device 1 may generate the corresponding knowledge graph. It is noted that the construction of the plurality of entries of knowledge data and the corresponding knowledge graph may be done by the server device 1 using a conventional method, and details thereof are omitted herein for the sake of brevity.

The user device 2 may be embodied using a personal computer, a laptop, a tablet, a smartphone or other suitable electronic devices, and includes a user-end communication module 21, a user-end input module 22, a user-end display module 23, a user-end camera module 24, a user-end processor 25, and a user-end data storage module 26. The user-end processor 25 is connected to the user-end communication module 21, the user-end input module 22, the user-end display module 23, the user-end camera module 24, and the user-end data storage module 26.

The user-end communication module 21, the user-end data storage module 26 and the user-end processor 25 may be embodied using hardware components that are similar to the server communication module 11, the server data storage module 12 and the server processor 13, respectively. The user-end data storage module 26 may store a software application such as a mobile application therein. The software application includes instructions that, when, executed by the user-end processor 25, causes the user-end processor 25 to implement operations as described below.

The user-end input module 22 may include a mouse/keyboard, a touchscreen or other suitable hardware components that enable the user to input a command through operation thereof.

The user-end display module 23 may be embodied using a display screen or a touchscreen. In some embodiments, the user-end input module 22 and the user-end display module 23 are integrated as a touchscreen.

The user-end camera module 24 may be embodied using a hardware camera that is configured to periodically capture images of the face of the user and to transmit the images to the server device 1 for processing.

In use, when the user operates the user device 2 to execute the software application, the user device 2 may establish a communication with the server device 1 to implement the method for interactive learning. In embodiments, the method includes a learning interactive process, a memory assistance process and a learning reminder process. Generally, the method is designed to guide the user to think on a question in order to obtain a correct answer to the question.

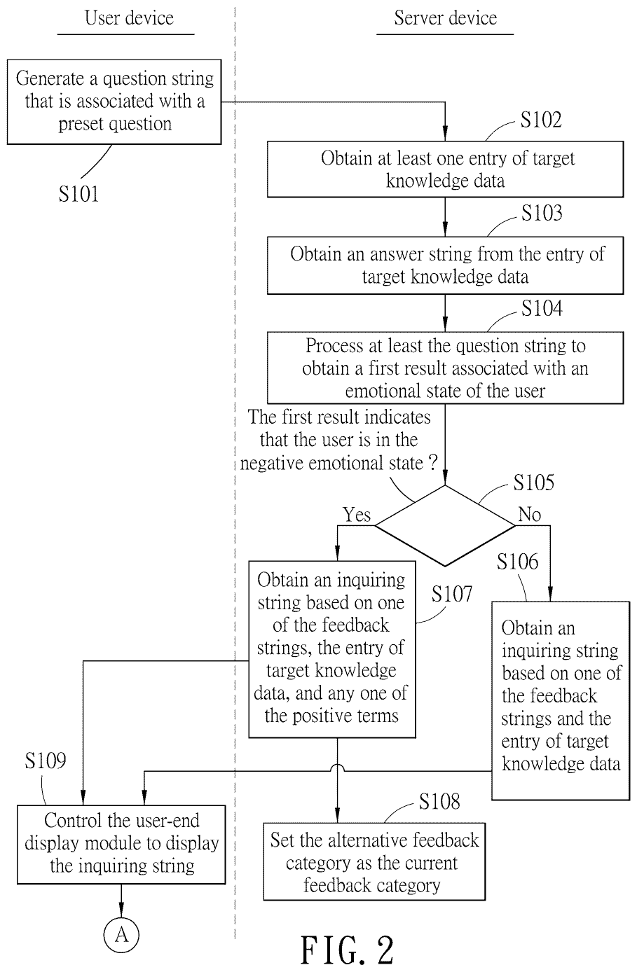

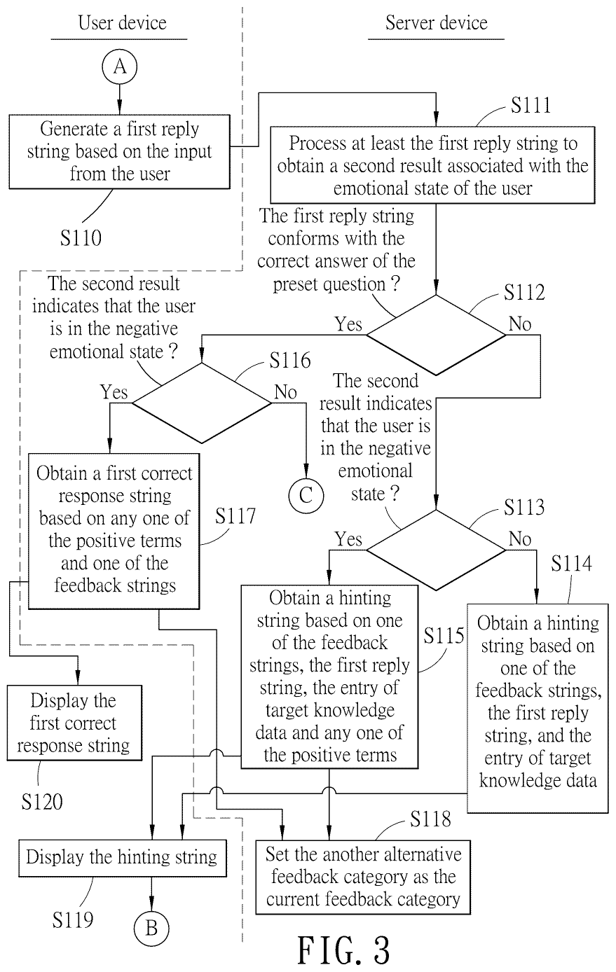

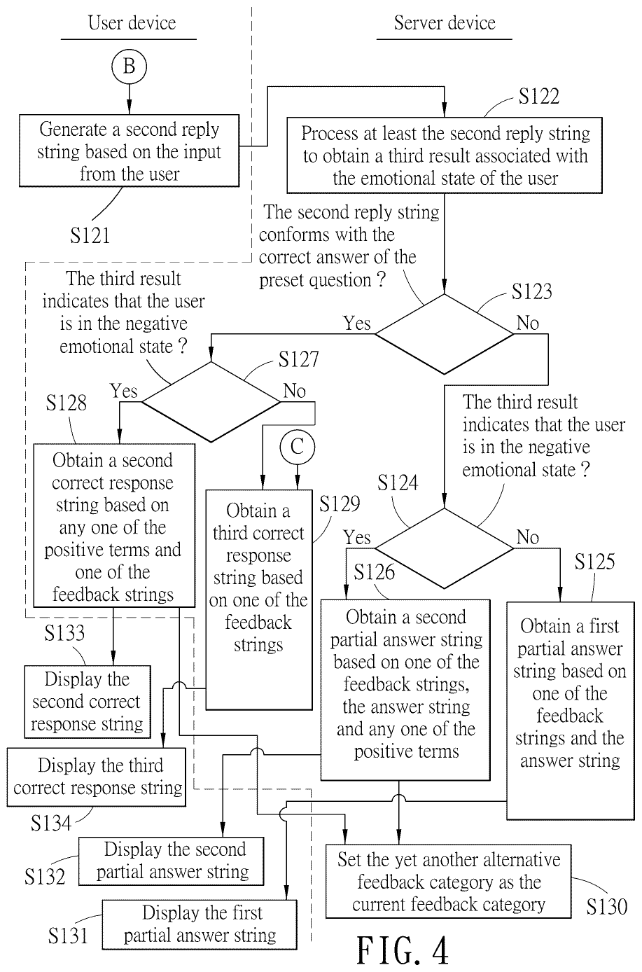

FIGS. 2, 3 and 4 constitute a flow chart of an exemplary learning interactive process of the method according to one embodiment of the disclosure. In this embodiment, the learning interactive process includes steps S101 to S134, and is implemented using the system 100 of FIG. 1. In use, the user may be using the user device 2 to answer a question provided by the user device 2, and the user-end camera module 24 is activated to capture facial images of the face of the user and transmit the facial images to the server device 1 periodically during the learning interactive process.

In step S101, after the user operates the user-end input module 22, the user-end input module 22 generates and transmits a user input command to the user-end processor 25. In response to receipt of the user input command, the user-end processor 25 generates a question string that is associated with a preset question, and transmits the question string to the server device 1.

In use, the user device 2 may store a number of preset questions. In response to receipt of the user input command, the user-end processor 25 generates the question string based on one of the preset questions. In some embodiments, the question string may be in the form of “please describe the three phases of water”.

It is noted that in some embodiments, the user input command may include a user answer inputted by the user to answer the preset question.

In step S102, in response to receipt of the question string and the facial images, the server processor 13 obtains at least one entry of target knowledge data that is selected from the plurality of entries of knowledge data. Specifically, the server processor 13 determines one of the plurality of entries of knowledge data that is associated with a correct answer of the preset question, and selects the one of the plurality of entries of knowledge data as an entry of target knowledge data. In some embodiments, a plurality of entries of target knowledge data may be obtained and used in the following steps.

In step S103, the server processor 13 uses the LLM to obtain an answer string from the entry of target knowledge data. Specifically, the server processor 13 may use the entry of target knowledge data as an input to the LLM stored in the server data storage 12, and uses the output of the LLM as the answer string. It is noted that the answer string may not be necessarily identical to the correct answer of the preset question, and may be utilized by the server processor 13 for further analysis.

In step S104, the server processor 13 processes at least the question string to obtain a first result associated with an emotional state of the user. Specifically, the operations of step S104 may include the server processor 13 using an emotion detection algorithm to process the question string.

In this embodiment, the emotion detection algorithm may be one that employs the technique as disclosed in the document by Tesfagergish, Senait Gebremichael, Jurgita Kapočiūtė-Dzikienė, and Robertas Dama§ evičius, “Zero-Shot Emotion Detection for Semi-Supervised Sentiment Analysis Using Sentence Transformers and Ensemble Learning”, in Applied Sciences, no. 17, 2022. It is noted that in other embodiments, different emotion detection algorithms may be employed, and since the use of emotion detection algorithms is known in the related art, details thereof are omitted herein for the sake of brevity.

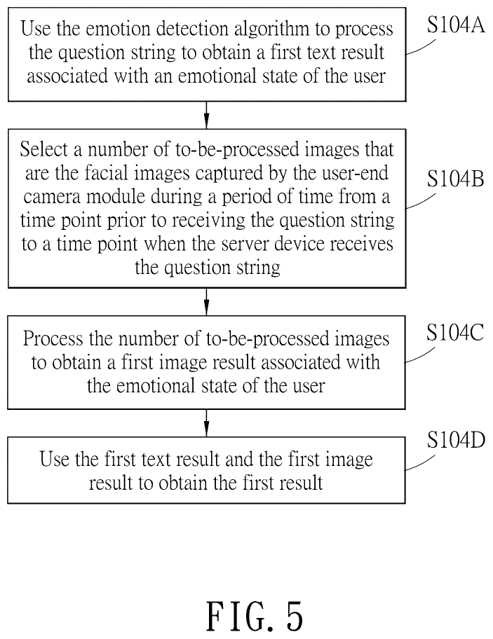

In some embodiments, the operations of step S104 may include further processing the facial images to obtain the first result. FIG. 5 is a flow chart illustrating sub-steps of the operations of step S104 according to one embodiment of the disclosure.

In sub-step S104A, the server processor 13 uses the emotion detection algorithm to process the question string to obtain a first text result associated with an emotional state of the user. Specifically, the first text result may indicate whether the user is in a negative emotional state when inputting the user answer to the preset question.

In sub-step S104B, the server processor 13 selects a number of to-be-processed images that are the facial images captured by the user-end camera module 24 during a period of time from a time point prior to receiving the question string to a time point when the server device 1 receives the question string (e.g., a few minutes).

In sub-step S104C, the server processor 13 processes the number of to-be-processed images to obtain a first image result associated with the emotional state of the user. Specifically, the operations of sub-step S104C may include the server processor 13 using a facial expression recognition algorithm to process the to-be-processed images.

In this embodiment, the facial expression recognition algorithm may be one that employs the technique as disclosed in the document by Zhang, Saining, Yuhang Zhang, Ye Zhang, Yufei Wang, and Zhigang Song, “A Dual-Direction Attention Mixed Feature Network for Facial Expression Recognition”, in Electronics, no. 17, 2023. It is noted that in other embodiments, different facial expression recognition algorithms may be employed, and since the use of facial expression recognition algorithms is known in the related art, details thereof are omitted herein for the sake of brevity.

Then, in sub-step S104D, the server processor 13 uses the first text result and the first image result to obtain the first result. It is noted that the operations of obtaining the first text result and the first image result may be done independently from each other, and the sub-steps S104A and S104B may be implemented in an arbitrary order.

In some embodiments, in implementing the operations of sub-step S104D, in the case that the first text result and the first image result indicate different emotional states, the server processor 13 may use the first text result to obtain the first result, as the text inputted by the user may reflect the actual emotional state of the user more accurately and is therefore prioritized.

In step S105, the server processor 13 determines whether the first result indicates that the user is in the negative emotional state. In the case that the first result indicates that the user is in the negative emotional state, the flow proceeds to step S107. Otherwise, in the case that the first result indicates that the user is not in the negative emotional state, the flow proceeds to step S106.

In step S106, the server processor 13 uses the LLM to obtain an inquiring string based on one of the feedback strings and the entry of target knowledge data. Specifically, the one of the feedback strings used in this step is arbitrarily selected from a current feedback category which is one of the feedback categories stored in the server data storage module 12, and the server processor 13 uses the one of the feedback strings and the entry of target knowledge data as an input to the LLM, and uses the output of the LLM as the inquiring string. In some embodiments, the server processor 13 may further instruct the LLM to output the inquiring string that is different from the correct answer to the preset question as the inquiring string. The inquiring string is then transmitted to the user device 2 for display to the user, so as to instruct the user to continue thinking for the correct answer to the preset question. Then, the flow proceeds to step S109.

In step S107, the server processor 13 obtains an inquiring string based on one of the feedback strings, the entry of target knowledge data, and any one of the positive terms. Specifically, the one of the feedback strings used in this step is arbitrarily selected from an alternative feedback category, which is one of the feedback categories stored in the server data storage module 12 and is different from the current feedback category, and the server processor 13 uses the one of the feedback strings, the entry of target knowledge data and the one of the positive terms as an input to the LLM, and uses the output of the LLM as the inquiring string. In some embodiments, the server processor 13 may further instruct the LLM to not directly output the correct answer to the preset question as the inquiring string. The inquiring string is then transmitted to the user device 2 for display to the user, so as to instruct the user, with encouragement, to continue thinking for the correct answer to the preset question.

In step S108, the server processor 13 sets the alternative feedback category as the current feedback category. Then, the flow proceeds to step S109. It is noted that the current feedback category may be adjusted based on the inputs of the user.

It is noted that in some embodiments, the server processor 13 may obtain the inquiring string based on the entry of target knowledge data as an input to the LLM. Specifically, the server processor 13 may instruct the LLM to generate the inquiring string as an output based on techniques such as “substitute, combine, adjust, modify, put to other uses, eliminate, reverse” (SCAMPER), five whys, the five W's and H, etc.

In step S109, in response to receipt of the inquiring string obtained in either step S106 or step S107, the user-end processor 25 controls the user-end display module 23 to display the inquiring string which serves to guide the user to think of the correct answer to the preset question, and to instruct the user to operate the user-end input module 22 to input a user answer.

After the user views the inquiring string displayed in step S109 and operates the user-end input module 22 to input a user answer to the preset question, in step S110, the user-end processor 25 generates a first reply string based on the input from the user, and controls the user-end communication module 21 to transmit the first reply string to the server device 1.

In step S111, in response to receipt of the first reply string, the server processor 13 processes at least the first reply string to obtain a second result associated with the emotional state of the user. Specifically, the operations of step S111 may include the server processor 13 using the emotion detection algorithm to process the first reply string. It is noted that the emotion detection algorithm may be embodied using one as described in step S104.

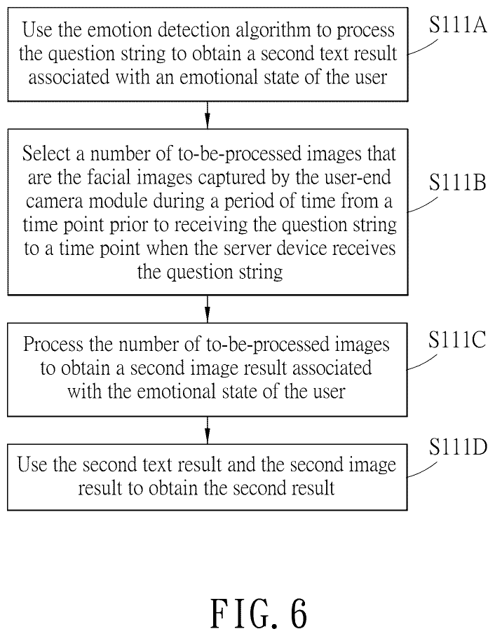

In some embodiments, the operations of step S111 may further include processing the facial images to obtain the second result. FIG. 6 is a flow chart illustrating sub-steps of the operations of step S111 according to one embodiment of the disclosure.

In sub-step S111A, the server processor 13 uses the emotion detection algorithm to process the first reply string to obtain a second text result associated with an emotional state of the user. Specifically, the second text result may indicate whether the user is in a negative emotional state when inputting the user answer to the preset question in response to the inquiring string displayed in step S109.

In sub-step S111B, the server processor 13 selects a number of to-be-processed images that are the facial images captured by the user-end camera module 24 during a period of time from a time point prior to receiving the first reply string (e.g., a few minutes prior to receiving the first reply string) to a time point when the server device 1 receives the first reply string.

In sub-step S111C, the server processor 13 processes the number of to-be-processed images to obtain a second image result associated with the emotional state of the user. Specifically, the operations of sub-step S111C may include the server processor 13 using a facial expression recognition algorithm to process the to-be-processed images in a manner similar to that of step S104.

Then, in sub-step S111D, the server processor 13 uses the second text result and the second image result to obtain the second result. It is noted that the operations of obtaining the second text result and the second image result may be done independently from each other, and the sub-steps S111A and S111B may be implemented in an arbitrary order. Also, in the case that the second text result and the second image result indicate different emotional state, the server processor 13 may obtain the second result using the second text result.

In step S112, the server processor 13 determines whether the first reply string conforms with the correct answer of the preset question. Specifically, the server processor 13 may use the LLM to compare the first reply string and the correct answer of the preset question, and in the case that the first reply string is identical or very similar to the correct answer of the preset question, the server processor 13 determines that the first reply string conforms with the correct answer of the preset question. In the case that the first reply string conforms with the correct answer of the preset question, the flow proceeds to step S116. Otherwise, the flow proceeds to step S113.

In step S113, the server processor 13 determines whether the second result indicates that the user is in the negative emotional state. In the case that the second result indicates that the user is in the negative emotional state, the flow proceeds to step S115. Otherwise, in the case that the second result indicates that the user is not in the negative emotional state, the flow proceeds to step S114.

In step S114, the server processor 13 uses the LLM to obtain a hinting string based on one of the feedback strings, the first reply string, and the entry of target knowledge data. Specifically, the one of the feedback strings used in this step is arbitrarily selected from the current feedback category, and the server processor 13 uses the one of the feedback strings, the first reply string and the entry of target knowledge data as an input to the LLM, and uses the output of the LLM as the hinting string. In some embodiments, the server processor 13 may further instruct the LLM to not directly output the correct answer to the preset question as the hinting string, but may include in the hinting string more hints to answering the question than included in the inquiring string. The hinting string is then transmitted to the user device 2 for display to the user, so as to instruct the user to continue thinking for the correct answer to the preset question. Then, the flow proceeds to step S119.

In step S115, the server processor 13 uses the LLM to obtain a hinting string based on one of the feedback strings, the first reply string, the entry of target knowledge data and any one of the positive terms. Specifically, the one of the feedback strings used in this step is arbitrarily selected from another alternative feedback category, which is one of the feedback categories stored in the server data storage module 12 and is different from the current feedback category, and the server processor 13 uses the one of the feedback strings, the first reply string, the entry of target knowledge data and the one of the positive terms as an input to the LLM, and uses the output of the LLM as the inquiring string. In some embodiments, the server processor 13 may further instruct the LLM to not directly output the correct answer to the preset question as the hinting string. The hinting string is then transmitted to the user device 2 for display to the user, so as to instruct the user, with encouragement, to continue thinking for the correct answer to the preset question.

In step S116, the server processor 13 determines whether the second result indicates that the user is in the negative emotional state. In the case that the second result indicates that the user is in the negative emotional state, the flow proceeds to step S117. Otherwise, in the case that the second result indicates that the user is not in the negative emotional state, the flow proceeds to step S129.

In step S117, the server processor 13 obtains a first correct response string based on any one of the positive terms and one of the feedback strings. Specifically, the one of the feedback strings used in this step is arbitrarily selected from the another alternative feedback category, and the server processor 13 uses the one of the positive terms and the one of the feedback strings as an input to the LLM, and uses the output of the LLM as the first correct response string. The first correct response string is then transmitted to the user device 2 for display to the user, so as to notify the user that his/her answer is correct. Then, the flow proceeds to step S120.

It is noted that in some embodiments, the server processor 13 may obtain the hinting string based on the first reply string and the entry of target knowledge data as an input to the LLM. Specifically, the server processor 13 may instruct the LLM to generate the hinting string as an output to include, for example, an answer of another questions similar to the preset question, a deconstruction of the preset question, a step-by-step breakdown, partial steps of obtaining the answer, etc.

After each of steps S115 and S117, in step S118, the server processor 13 sets the another alternative feedback category as the current feedback category.

In step S119, in response to receipt of the hinting string obtained in either step S114 or step S115, the user-end processor 25 controls the user-end display module 23 to display the hinting string which serves to provide hints to further guide the user to think of the correct answer to the preset question, and to instruct the user to operate the user-end input module 22 to input another user answer. Then, the flow proceeds to step S121.

In step S120, in response to receipt of the first correct response string, the user-end processor 25 controls the user-end display module 23 to display the first correct response string which serves to notify the user, with encouragements, that his/her answer is correct. At this stage, the previous interactions between the user and the system 100 may be recorded, and the method may be terminated or restarted for another question.

After the user views the hinting string and operates the user input module 22 to input his/her answer, in step S121, the user processor 25 generates a second reply string based on the input from the user, and controls the user communication module 21 to transmit the second reply string to the server device 1.

In step S122, the server processor 13 processes at least the second reply string to obtain a third result associated with the emotional state of the user. Specifically, the operations of step S122 may include the server processor 13 using the emotion detection algorithm to process the second reply string. It is noted that the emotion detection algorithm may be embodied using one as described in step S104.

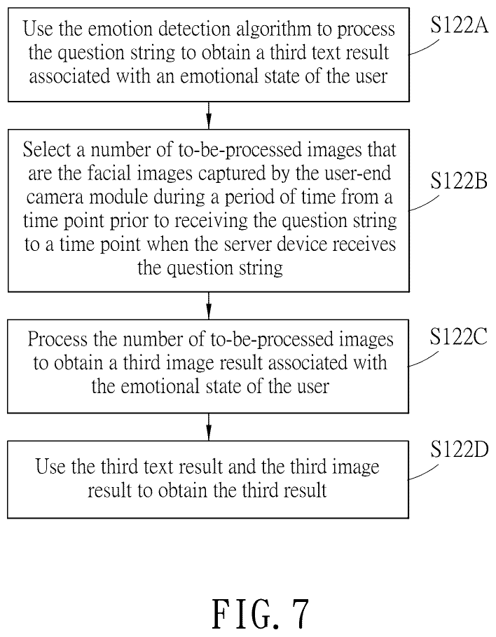

In some embodiments, the operations of step S122 may further include processing the facial images to obtain the third result. FIG. 7 is a flow chart illustrating sub-steps of the operations of step S122 according to one embodiment of the disclosure.

In sub-step S122A, the server processor 13 uses the emotion detection algorithm to process the second reply string to obtain a third text result associated with the emotional state of the user. Specifically, the third text result may indicate whether the user is in a negative emotional state when inputting the user answer to the preset question in response to the hinting string displayed in step S119.

In sub-step S122B, the server processor 13 selects a number of to-be-processed images that are the facial images captured by the user-end camera module 24 during a period of time from a time point prior to receiving the second reply string (e.g., a few minutes prior to receiving the second reply string) to a time point when the server device 1 receives the second reply string.

In sub-step S122C, the server processor 13 processes the number of to-be-processed images to obtain a third image result associated with the emotional state of the user. Specifically, the operations of sub-step S122C may include the server processor 13 using a facial expression recognition algorithm to process the to-be-processed images in a manner similar to that of step S104.

Then, in sub-step S122D, the server processor 13 uses the third text result and the third image result to obtain the third result. It is noted that the operations of obtaining the third text result and the third image result may be done independently from each other, and the sub-steps S122A and S122B may be implemented in an arbitrary order. Also, in the case that the third text result and the third image result indicate different emotional state, the server processor 13 may obtain the third result using the third text result.

In step S123, the server processor 13 determines whether the second reply string conforms with the correct answer of the preset question. Specifically, the server processor 13 may compare the second reply string and the correct answer of the preset question, and in the case that the second reply string is identical or very similar to the correct answer of the preset question, the server processor 13 determines the second reply string conforms with the correct answer of the preset question. In the case that the second reply string conforms with the correct answer of the preset question, the flow proceeds to step S127. Otherwise, the flow proceeds to step S124.

In step S124, the server processor 13 determines whether the third result indicates that the user is in the negative emotional state. In the case that the third result indicates that the user is in the negative emotional state, the flow proceeds to step S126. Otherwise, in the case that the third result indicates that the user is not in the negative emotional state, the flow proceeds to step S125.

In step S125, the server processor 13 obtains a first partial answer string based on one of the feedback strings and the answer string obtained in step S103. Specifically, the one of the feedback strings used in this step is arbitrarily selected from the current feedback category, and the server processor 13 uses the one of the feedback strings and the answer string as an input to the LLM, and uses the output of the LLM as the first partial answer string. In some embodiments, the server processor 13 may further instruct the LLM to not directly output the correct answer to the preset question as the first partial answer string, but may include in the first partial answer string more explanations to answering the preset question than included in the hinting string by providing, for example, explanations on principles and concepts related to the preset question.

The first partial answer string is then transmitted to the user device 2 for display to the user, so as to instruct the user to continue thinking for the correct answer to the preset question. Then, the flow proceeds to step S131.

In step S126, the server processor 13 obtains a second partial answer string based on one of the feedback strings, the answer string and any one of the positive terms. Specifically, the one of the feedback strings used in this step is arbitrarily selected from yet another alternative feedback category, which is one of the feedback categories stored in the server data storage module 12 and is different from the current feedback category, and the server processor 13 uses the one of the feedback strings, the answer string and the one of the positive terms as an input to the LLM, and uses the output of the LLM as the second partial answer string. In some embodiments, the server processor 13 may further instruct the LLM to not directly output the correct answer to the preset question as the second partial answer string. In some embodiments, the second partial answer string may include more information needed for answering the preset question, such as a complete step-by-step exemplary solution. The second partial answer string is then transmitted to the user device 2 for display to the user, so as to instruct the user, with encouragement, to continue thinking for the correct answer to the preset question. Then, the flow proceeds to step S130. In some embodiments, after it is determined that the second reply string does not conform with the correct answer of the preset question, the server processor 13 may directly obtain and transmit one of a first partial answer string and the answer string to the user device 2.

In step S127, the server processor 13 determines whether the third result indicates that the user is in the negative emotional state. In the case that the third result indicates that the user is in the negative emotional state, the flow proceeds to step S128. Otherwise, in the case that the third result indicates that the user is not in the negative emotional state, the flow proceeds to step S129.

In step S128, the server processor 13 obtains a second correct response string based on any one of the positive terms and one of the feedback strings. Specifically, the one of the feedback strings used in this step is arbitrarily selected from yet another alternative feedback category, which is one of the feedback categories stored in the server data storage module 12 and is different from the current feedback category, and the server processor 13 uses the one of the positive terms and the one of the feedback strings as an input to the LLM, and uses the output of the LLM as the second correct response string. The second correct response string is then transmitted to the user device 2 for display to the user, so as to notify the user, with encouragements, that his/her answer is correct. Then, the flow proceeds to step S133.

In step S129, the server processor 13 obtains a third correct response string based on one of the feedback strings. Specifically, the one of the feedback strings used in this step is arbitrarily selected from the yet another alternative feedback category, and the server processor 13 uses the one of the feedback strings as an input to the LLM, and uses the output of the LLM as the third correct response string. The third correct response string is then transmitted to the user device 2 for display to the user, so as to notify the user that his/her answer is correct. Then, the flow proceeds to step S134.

It is noted that in some embodiments, in the case it is determined that the second reply string does not conform with the correct answer of the preset question, the server processor 13 may control the server communication module 11 to directly transmit the answer string to the user device 1.

After each of step S126 and step S128, in step S130, the server processor 13 sets the yet another alternative feedback category as the current feedback category.

In step S131, in response to receipt of the first partial answer string, the user-end processor 25 controls the user-end display module 23 to display the first partial answer string which serves to provide detailed hints to further guide the user to think of the correct answer to the preset question. In some embodiments, the first partial answer string also instructs the user to operate the user-end input module 22 to input another user answer, and then, the flow may return to step S121 for another iteration, and in the case that the another user answer from the user device 1 does not conform with the correct answer of the preset question, the server processor 13 may control the server communication module 11 to directly transmit the answer string to the user device 1.

In step S132, in response to receipt of the second partial answer string, the user-end processor 25 controls the user-end display module 23 to display the second partial answer string which serves to provide detailed hints to further guide the user to think of the correct answer to the preset question. In some embodiments, the second partial answer string also instructs the user, with encouragements, to operate the user-end input module 22 to input another user answer, and then, the flow may return to step S121 for another iteration, and in the case that the another user answer from the user device 1 does not conform with the correct answer of the preset question, the server processor 13 may control the server communication module 11 to directly transmit the answer string to the user device 1.

In step S133, in response to receipt of the second correct response string, the user-end processor 25 controls the user-end display module 23 to display the second correct response string which serves to notify the user, with encouragements, that his/her answer is correct. At this stage, the previous interactions between the user and the system 100 may be recorded, and the method may be terminated or restarted for another question.

In step S134, in response to receipt of the third correct response string, the user-end processor 25 controls the user-end display module 23 to display the third correct response string which serves to notify the user that his/her answer is correct. At this stage, the previous interactions between the user and the system 100 may be recorded, and the method may be terminated or restarted for another question. As such, the learning interactive process is completed.

It is noted that in this embodiment, the LLM was pre-trained for implementing the operations of instruction-tuning using various training datasets in order to be able to generate the various strings in different stages of the learning interactive process. For example, to generate the inquiring string, a dataset may include a plurality of entries of training data, each including a question string and an inquiring string. To generate the hinting string, a dataset may include a plurality of entries of training data, each including a first response string and a hinting string. To generate the first partial answer string and the second partial answer string, a dataset may include a plurality of entries of training data, each including a second response string and a partial answer string.

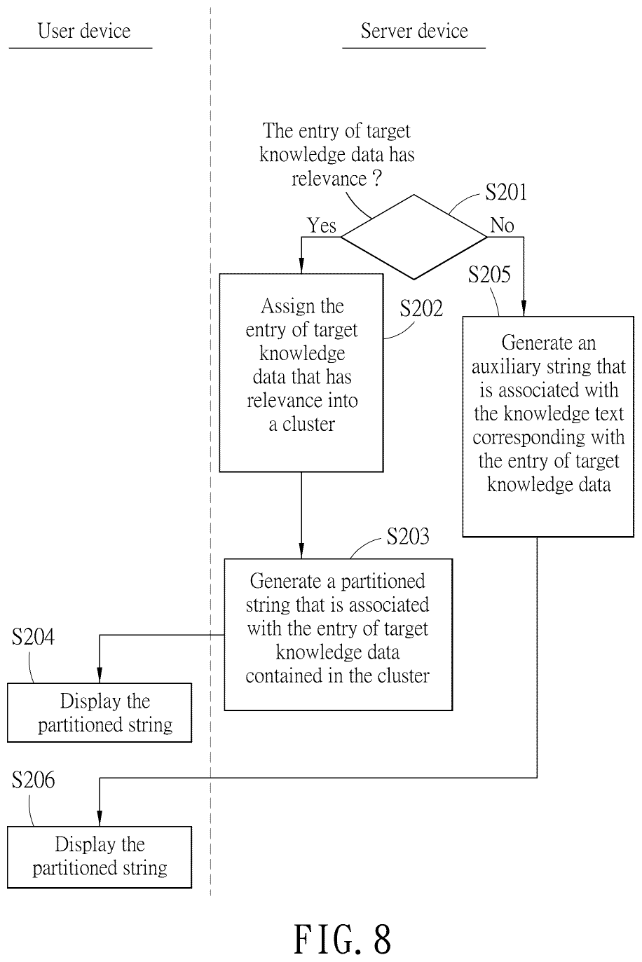

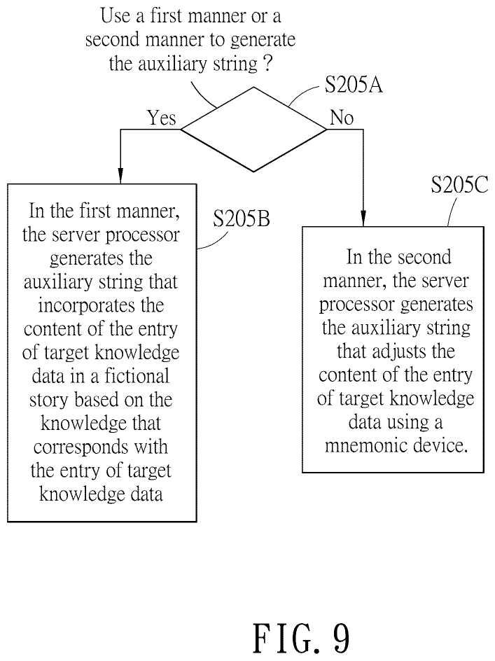

FIGS. 8 and 9 constitute a flow chart of an exemplary memory assistance process of the method according to one embodiment of the disclosure. In this embodiment, the memory assistance process is implemented using the system 100 of FIG. 1. Additionally, in this embodiment, for the sake of simplified description, only one entry of target knowledge data is present, but in other embodiments, a plurality of entries of target knowledge data may be present.

In step S201, the server processor 13 determines whether the entry of target knowledge data has relevance. Specifically, in embodiments, the operations of step S201 include the server processor 13 identifying a plurality of entities from the knowledge graph that corresponds with the entry of target knowledge data, and determining whether there exists a relation between any two among the plurality of entities. In the case there exists a relation between any two among the plurality of entities, it is determined that the entry of target knowledge data has relevance. Otherwise, in the case that there is no relation between any two among the plurality of entities, it is determined that the entry of target knowledge data does not have relevance.

In the case that it is determined that the entry of target knowledge data has relevance, the flow proceeds to step S202. Otherwise, the flow proceeds to step S205.

In step S202, the server processor 13 assigns the entry of target knowledge data that has relevance into a cluster, based on the knowledge graph that corresponds with the entry of target knowledge data.

In some embodiments, a plurality of entries of target knowledge data that are deemed to have relevance may be present, and are assigned to a plurality of clusters. As such, each cluster contains at least one entry of target knowledge data. In some cases, the operations of step S202 may be repeated multiple times, such that some clusters include a plurality of entries of target knowledge data.

In step S203, for each cluster, the server processor 13 generates a partitioned string that is associated with the entry of target knowledge data contained in the cluster. Specifically, the server processor 13 uses the LLM to generate the partitioned string. Then, the server processor 13 controls the server communication module 11 to transmit the partitioned string to the user device 1.

In embodiments, the entry of target knowledge data may include a text or other content associated with a specific subject (e.g., a lesson of a textbook), and the partitioned string may include a summary of the entry of target knowledge data, which serves to assist the user to better remember the content of the entry of target knowledge data.

Then, in step S204, in response to receipt of the partitioned string, the user-end processor 25 controls the user-end display module 23 to display the partitioned string which serves to assist the user to remember the content of the entry of target knowledge data.

In step S205, the server processor 13 generates an auxiliary string that is associated with the knowledge text corresponding with the entry of target knowledge data. Specifically, the server processor 13 uses the LLM to generate the auxiliary string. Then, the server processor 13 controls the server communication module 11 to transmit the auxiliary string to the user device 1. The auxiliary string generally serves to assist the user to better remember the content of the knowledge text.

FIG. 9 is a flow chart illustrating sub-steps of the operations of step S205 according to one embodiment of the disclosure.

In sub-step 205A, the server processor 13 determines whether to use a first manner or a second manner to generate the auxiliary string. In some embodiments, the server processor 13 determines whether a number of words contained in the entry of target knowledge data is larger than a predetermined number. In the case that the number of words contained in the entry of target knowledge data is larger than the predetermined number, the flow proceeds to sub-step S205B. Otherwise, the flow proceeds to sub-step S205C.

In other embodiments, the server processor 13 determines whether the content of the entry of target knowledge data is related to a subject that is abstract and needs more comprehension on connections among events and/or concepts, such as history, physics, chemistry, math, etc., or is related to a subject that is more related to remembering details, sequences and/or grouping, such as Chinese, English, geography, etc. In the case of the former, the flow proceeds to sub-step S205B. Otherwise, the flow proceeds to sub-step S205C.

In sub-step S205B, in the first manner, the server processor 13 generates the auxiliary string that incorporates the content of the entry of target knowledge data in a fictional story based on the knowledge that corresponds with the entry of target knowledge data. Specifically, the server processor 13 may instruct the LLM to generate the auxiliary string by creating the fictional story to incorporate the content of the entry of target knowledge. Then, the server processor 13 controls the server communication module 11 to transmit the auxiliary string to the user device 1.

In sub-step S205C, in the second manner, the server processor 13 generates the auxiliary string that adjusts the content of the entry of target knowledge data using a mnemonic device. Specifically, the server processor 13 may instruct the LLM to generate the auxiliary string by applying the mnemonic device to alter the content of the entry of target knowledge into a form that is more memorable to the user. Then, the server processor 13 controls the server communication module 11 to transmit the auxiliary string to the user device 1.

Examples of the mnemonic device may include using a short sentence (e.g., “Never Eat Soggy Waffles”) to help remembering general knowledge (the order of compass directions (North, East, South, West) in a clockwise direction), or using abbreviations (e.g., HOMES) to help remembering general knowledge (the names of the Great Lakes: Huron, Ontario, Michigan, Erie, and Superior).

After step S205, in step S206, in response to receipt of the partitioned string, the user-end processor 25 controls the user-end display module 23 to display the partitioned string which serves to assist the user to remember the content of the entry of target knowledge data. As such, the memory assistance process is completed.

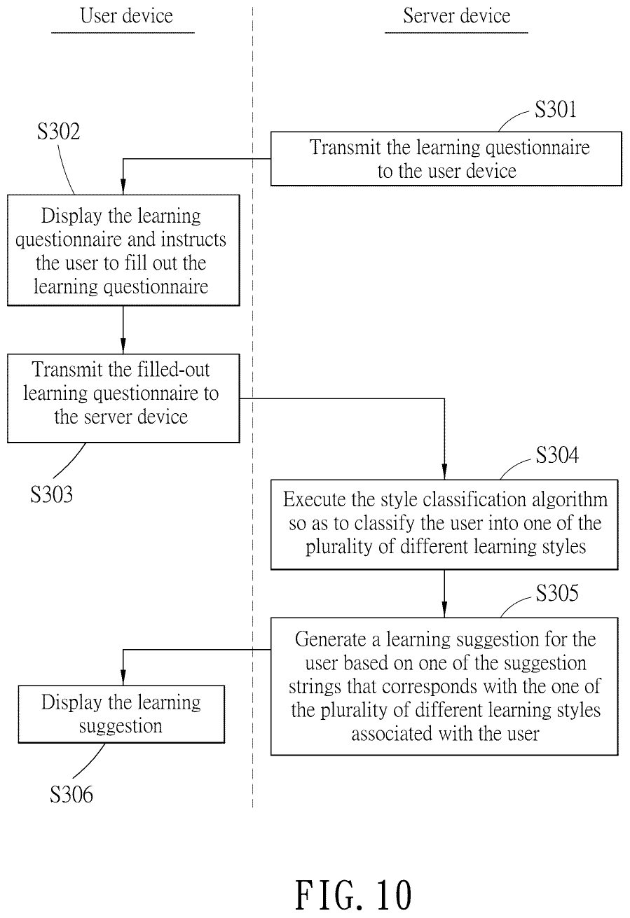

FIG. 10 is a flow chart of an exemplary learning reminder process of the method according to one embodiment of the disclosure. In this embodiment, the learning reminder process is implemented using the system 100 of FIG. 1.

In step S301, the server processor 13 controls the server communication module 11 to transmit the learning questionnaire to the user device 1.

Then, in step S302, in response to receipt of the learning questionnaire, the user-end processor 25 controls the user-end display module 23 to display the learning questionnaire and instructs the user to fill out the learning questionnaire, in order to better understand the learning status of the user.

In step S303, in response to the user operating the user-end input module 22 to fill out the learning questionnaire, the user-end processor 25 generates a filled-out learning questionnaire and controls the user-end communication module 21 to transmit the filled-out learning questionnaire to the server device 1.

In step S304, in response to receipt of the filled-out learning questionnaire, the server processor 13 executes the style classification algorithm so as to classify the user into one of the plurality of different learning styles. In embodiments, the style classification algorithm may be pre-trained using a classification algorithm as a backbone, and using a plurality of style training datasets. The classification algorithm may be one of a Naive Bayes classifier, a support vector machine (SVM), a decision tree, etc. Each of the plurality of style training datasets may include a training questionnaire, a training learning record and an associated learning style. After the training, the style classification algorithm is able to classify the user into one of the plurality of different learning styles based on the filled-out learning questionnaire and the learning record associated with the user.

Then, in step S305, the server processor 13 generates a learning suggestion for the user based on one of the suggestion strings that corresponds with the one of the plurality of different learning styles associated with the user. The learning suggestion may include reminders to the user about things to keep in mind in future learning. Then, the server processor 13 controls the server communication module 11 to transmit the learning suggestion to the user device 1.

Then, in step S306, the user-end processor 25 controls the user-end display module 23 to display the learning suggestion. As such, the learning reminder process is completed.

To sum up, the embodiments of the disclosure provides a method for interactive learning. In the method, based on different inputs of the user, the server device may incorporate an LLM to provide different assistances to guide the user to obtain the correct answer to a preset question instead of giving the correct answer outright. In this manner, the method provides an interactive learning process that is similar to providing instructional scaffolding to the user. Additionally, the method further includes the memory assistance process to assist the user in remembering content of different subjects, and the learning reminder process to remind the user of things to keep in mind in future learning, based on an assigned learning styles associated with the user.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for interactive learning for a user to obtain a correct answer to a preset question, the method being implemented using a server device that is in communication with a user device held by the user, the server device storing a large language model (LLM) and a plurality of entries of knowledge data that are related to a plurality of knowledge texts, respectively, the method comprising steps of:
a) in response to receipt of a question string from the user device, obtaining at least one entry of target knowledge data that is selected from the plurality of entries of knowledge data and that is associated with the correct answer of the present question;
b) using the LLM to obtain an answer string from the entry of target knowledge data;
c) using the LLM to obtain an inquiring string based on the entry of target knowledge data, the inquiring string being different from the correct answer of the preset question, and transmitting the inquiring string to the user device;
d) in response to receipt of a first reply string from the user device, determining whether the first reply string conforms with the correct answer of the preset question;
e) in the case that the first reply string does not conform with the correct answer of the preset question, using the LLM to obtain a hinting string based on the first reply string and the entry of target knowledge data, and transmitting the hinting string to the user device, the hinting string including hints to instruct the user to continue thinking for the correct answer to the preset question;
f) in response to receipt of a second reply string from the user device, determining whether the second reply string conforms with the correct answer of the preset question; and
g) in the case it is determined that the second reply string does not conform with the correct answer of the preset question, obtaining and transmitting one of a first partial answer string and the answer string to the user device, the first partial answer string being obtained based on one of the feedback strings and the answer string.

2. The method as claimed in claim 1, further comprising:
prior to step a), generating, for each of the plurality of entries of knowledge data, a corresponding knowledge graph;
i) after step a), determining whether the entry of target knowledge data has relevance based on the knowledge graph that corresponds with the entry of target knowledge data;
j) in the case that it is determined that the entry of target knowledge data has relevance, assigning the entry of target knowledge data into a cluster, based on the knowledge graph; and
k) using the LLM to generate a partitioned string that is associated with the entry of target knowledge data contained in the cluster, and transmitting the partitioned string to the user device.

3. The method as claimed in claim 2, wherein step i) includes identifying a plurality of entities from the knowledge graph that corresponds with the entry of target knowledge data, and determining whether there exists a relation between any two among the plurality of entities,
wherein, in the case there exists a relation between any two among the plurality of entities, it is determined that the entry of target knowledge data has relevance.

4. The method as claimed in claim 2, further comprising, after step i):
l) in the case that it is determined that the entry of target knowledge data does not have relevance, using the LLM to generate an auxiliary string that is associated with the knowledge graph corresponding with the entry of target knowledge data, and that is for assisting the user to better remember the content of the knowledge text; and
m) transmitting the auxiliary string to the user device.

5. The method as claimed in claim 4, wherein step l) includes:
determining whether to use a first manner or a second manner to generate the auxiliary string;
in the first manner, using the LLM to generate the auxiliary string that incorporates the content of the entry of target knowledge data in a fictional story; and
in the second manner, using the LLM to generate the auxiliary string that adjusts the content of the entry of target knowledge data using a mnemonic device.

6. The method as claimed in claim 1, the server device further storing a plurality of positive terms for encouraging the user, a plurality of feedback categories each being associated with a specific feedback style, each of the feedback categories including a plurality of feedback strings, the method further comprising, prior to step c):
n) processing at least the question string to obtain a first result associated with an emotional state of the user using an emotion detection algorithm, the first result indicating whether the user is in a negative emotional state;
wherein step c) includes sub-steps of
c-1) in the case that the user is not in the negative emotional state, obtaining the inquiring string based on one of the feedback strings and the entry of target knowledge data, the one of the feedback strings being selected from a current feedback category which is one of the plurality of feedback categories;
c-2) in the case that the user is in the negative emotional state, obtaining the inquiring string based on one of the feedback strings, the entry of target knowledge data, and one of the positive terms, the one of the feedback strings being selected from an alternative feedback category, which is one of the plurality of feedback categories and is different from the current feedback category; and
c-3) setting the alternative feedback category as the current feedback category.

7. The method as claimed in claim 6, the user device including a user-end camera module that periodically captures facial images of the user and being configured to transmit the facial images to the server device, wherein step n) includes sub-steps of:
n-1) using the emotion detection algorithm to process the question string to obtain a first text result associated with an emotional state of the user;
n-2) selecting a number of to-be-processed images that are the facial images captured by the user-end camera module during a period of time from a time point prior to receiving the question string to a time point when the server device receives the question string;
n-3) processing the number of to-be-processed images to obtain a first image result associated with the emotional state of the user; and
n-4) using the first text result and the first image result to obtain the first result.

8. The method as claimed in claim 1, the server device further storing a plurality of positive terms for encouraging the user, a plurality of feedback categories each being associated with a specific feedback style, each of the feedback categories including a plurality of feedback strings, the method further comprising, prior to step e):
o) processing at least the first reply string to obtain a second result associated with an emotional state of the user using an emotion detection algorithm, the second result indicating whether the user is in a negative emotional state;
wherein step e) includes the sub-steps of
e-1) in the case that the user is not in the negative emotional state, obtaining the hinting string based on one of the feedback strings, the first reply string, and the entry of target knowledge data, the one of the feedback strings being selected from a current feedback category which is one of the plurality of feedback categories;
e-2) in the case that the user is in the negative emotional state, obtaining the hinting string based on one of the feedback strings, the first reply string, the entry of target knowledge data and one of the positive terms, the one of the feedback strings being selected from an alternative feedback category, which is one of the plurality of feedback categories and is different from the current feedback category; and
e-3) setting the alternative feedback category as the current feedback category.

9. The method as claimed in claim 8, the user device including a user-end camera module that periodically captures facial images of the user and that is configured to transmit the facial images to the server device, wherein step o) includes the sub-steps of:
o-1) using the emotion detection algorithm to process the question string to obtain a second text result associated with an emotional state of the user;
o-2) selecting a number of to-be-processed images that are the facial images captured by the user-end camera module during a period of time from a time point prior to receiving the first reply string to a time point when the server device receives the first reply string;
o-3) processing the number of to-be-processed images to obtain a second image result associated with the emotional state of the user; and
o-4) using the second text result and the second image result to obtain the second result.

10. The method as claimed in claim 1, the server device further storing a learning record associated with the user, a plurality of suggestion strings that correspond with a plurality of different learning styles, respectively, and a style classification algorithm that is configured to classify the user into one of the plurality of different learning styles, the method further comprising:
in response to receipt of a filled-out learning questionnaire from the user device, executing the style classification algorithm so as to classify the user into one of the plurality of different learning styles based on the filled-out learning questionnaire and the learning record associated with the user; and
generating a learning suggestion for the user based on one of the suggestion strings that corresponds with the one of the plurality of different learning styles associated with the user, and transmitting the learning suggestion to the user device.

11. A server device for interactive learning for a user to obtain a correct answer to a preset question, the server device comprising a server communication module for establishing a communication with a user device held by the user, a server data storage module that stores a large language model (LLM) and a plurality of entries of knowledge data that are related to a plurality of knowledge texts, respectively, and a server processor that is electrically connected to the server communication module and the server data storage module, and that is programmed to:
in response to receipt of a question string from the user device, obtain at least one entry of target knowledge data that is selected from the plurality of entries of knowledge data and that is associated with the correct answer of the present question;
use the LLM to obtain an answer string from the entry of target knowledge data;
use the LLM to obtain an inquiring string based on the entry of target knowledge data, the inquiring string being different from the correct answer of the preset question, and control the server communication module to transmit the inquiring string to the user device;
in response to receipt of a first reply string from the user device, determine whether the first reply string conforms with the correct answer of the preset question;
in the case that the first reply string does not conform with the correct answer of the preset question, use the LLM to obtain a hinting string based on the first reply string and the entry of target knowledge data, and control the server communication module to transmit the hinting string to the user device, the hinting string including hints to instruct the user to continue thinking for the correct answer to the preset question;
in response to receipt of a second reply string from the user device, determine whether the second reply string conforms with the correct answer of the preset question; and
in the case it is determined that the second reply string does not conform with the correct answer of the preset question, control the server communication module to transmit one of a first partial answer string and the answer string to the user device, the first partial answer string being obtained based on one of the feedback strings and the answer string.

12. The server device as claimed in claim 11, wherein the server processor is further programmed to:
prior to obtaining the at least one entry of target knowledge data, generate, for each of the plurality of entries of knowledge data, a corresponding knowledge graph;
after obtaining the at least one entry of target knowledge data, determine whether the entry of target knowledge data has relevance based on the knowledge graph that corresponds with the entry of target knowledge data;
in the case that it is determined that the entry of target knowledge data has relevance, assign the entry of target knowledge data into a cluster, based on the knowledge graph; and
use the LLM to generate a partitioned string that is associated with the entry of target knowledge data contained in the cluster, and transmitting the partitioned string to the user device.

13. The server device as claimed in claim 12, wherein the server processor determines whether the entry of target knowledge data has relevance by identifying a plurality of entities from the knowledge graph that corresponds with the entry of target knowledge data, and determining whether there exists a relation between any two among the plurality of entities,
wherein, in the case there exists a relation between any two among the plurality of entities, it is determined that the entry of target knowledge data has relevance.

14. The server device as claimed in claim 12, wherein the server processor is further programmed to, after determining whether the entry of target knowledge data has relevance:
in the case that it is determined that the entry of target knowledge data does not have relevance, use the LLM to generate an auxiliary string that is associated with the knowledge graph corresponding with the entry of target knowledge data, and that is for assisting the user to better remember the content of the knowledge text; and
control the server communication module to transmit the auxiliary string to the user device.

15. The server device as claimed in claim 14, wherein the server processor generates the auxiliary string by:
determining whether to use a first manner or a second manner to generate the auxiliary string;
in the first manner, using the LLM to generate the auxiliary string that incorporates the content of the entry of target knowledge data in a fictional story; and
in the second manner, using the LLM to generate the auxiliary string that adjusts the content of the entry of target knowledge data using a mnemonic device.

16. The server device as claimed in claim 11, wherein the server data storage module further stores a plurality of positive terms for encouraging the user, a plurality of feedback categories each being associated with a specific feedback style, each of the feedback categories including a plurality of feedback strings, the server processor is further programmed to, prior to obtain the inquiring string:
process at least the question string to obtain a first result associated with an emotional state of the user using an emotion detection algorithm, the first result indicating whether the user is in a negative emotional state;
wherein the server processor obtains the inquiring string by
in the case that the user is not in the negative emotional state, obtaining the inquiring string based on one of the feedback strings and the entry of target knowledge data, the one of the feedback strings being selected from a current feedback category which is one of the plurality of feedback categories;
in the case that the user is in the negative emotional state, obtaining the inquiring string based on one of the feedback strings, the entry of target knowledge data, and one of the positive terms, the one of the feedback strings being selected from an alternative feedback category, which is one of the plurality of feedback categories and is different from the current feedback category; and
setting the alternative feedback category as the current feedback category.

17. The server device as claimed in claim 16, the user device including a user-end camera module that periodically captures facial images of the user and being configured to transmit the facial images to the server device, wherein the server processor obtains a first result by:
using the emotion detection algorithm to process the question string to obtain a first text result associated with an emotional state of the user;
selecting a number of to-be-processed images that are the facial images captured by the user-end camera module during a period of time from a time point prior to receiving the question string to a time point when the server device receives the question string;
processing the number of to-be-processed images to obtain a first image result associated with the emotional state of the user; and
using the first text result and the first image result to obtain the first result.

18. The server device as claimed in claim 11, wherein the server data storage module further stores a plurality of positive terms for encouraging the user, a plurality of feedback categories each being associated with a specific feedback style, each of the feedback categories including a plurality of feedback strings, the server processor is further programmed to, prior to obtaining the hinting string:
process at least the first reply string to obtain a second result associated with an emotional state of the user using an emotion detection algorithm, the second result indicating whether the user is in a negative emotional state;
wherein the server processor obtains the hinting string by
in the case that the user is not in the negative emotional state, obtaining the hinting string based on one of the feedback strings, the first reply string, and the entry of target knowledge data, the one of the feedback strings being selected from a current feedback category which is one of the plurality of feedback categories;
in the case that the user is in the negative emotional state, obtaining the hinting string based on one of the feedback strings, the first reply string, the entry of target knowledge data and one of the positive terms, the one of the feedback strings being selected from an alternative feedback category, which is one of the plurality of feedback categories and is different from the current feedback category; and
setting the alternative feedback category as the current feedback category.

19. The server device as claimed in claim 18, the user device including a user-end camera module that periodically captures facial images of the user and that is configured to transmit the facial images to the server device, wherein the server processor obtains the second result by:
using the emotion detection algorithm to process the question string to obtain a second text result associated with an emotional state of the user;
selecting a number of to-be-processed images that are the facial images captured by the user-end camera module during a period of time from a time point prior to receiving the first reply string to a time point when the server device receives the first reply string;
processing the number of to-be-processed images to obtain a second image result associated with the emotional state of the user; and
using the second text result and the second image result to obtain the second result.

20. The server device as claimed in claim 11, wherein the server data storage module further stores a learning record associated with the user, a plurality of suggestion strings that correspond with a plurality of different learning styles, respectively, and a style classification algorithm that is configured to classify the user into one of the plurality of different learning styles, the server processor is further programmed to:
in response to receipt of a filled-out learning questionnaire from the user device, execute the style classification algorithm so as to classify the user into one of the plurality of different learning styles based on the filled-out learning questionnaire and the learning record associated with the user; and
generate a learning suggestion for the user based on one of the suggestion strings that corresponds with the one of the plurality of different learning styles associated with the user, and control the server communication module to transmit the learning suggestion to the user device.
